(19) United States
(12) Patent Application Publication
(10) Pub. No.: US 2002/0124157 A1
(43) Pub. Date: Sep. 5, 2002

(54) Method and apparatus for fast operand access stage in a CPU design using a cache-like structure

(75) Inventors: Hung Qui Le, Austin, TX (US); Dung Quoc Nguyen, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/798,293

(22) Filed: Mar. 1, 2001

(51) Int. Cl. G06F 9/00

(52) U.S. Cl. 712/225

(57) ABSTRACT

An operand buffer is provided, each entry of which is allocated to an instruction in the issue queue. Thus, the operand buffer has the same number of entries as the issue queue. A register file is implemented for architected registers and temporary data. Data in the operand buffers are written from the register file at the time entries are allocated. When an instruction executes, there is no need for the corresponding entry in the operand buffer and the entry is de-allocated. The operand buffer has fewer entries than the register file. Thus, an operand access stage requires a read of the operand buffer rather than the register file and the operand buffer can be read in one cycle.

### BACKGROUND OF THE INVENTION

1. Technical Field

The present invention relates to data processing and, in particular, to operand access in a microprocessor design. Still more particularly, the present invention provides a method and apparatus for speeding up the operand access stage in a microprocessor design using a cache-like structure.

2. Description of Related Art

As instructions are dispatched in a microprocessor, operands for the instructions are read from a register file. FIG. 1 is a block diagram of a prior art microprocessor design. As an instruction is received from dispatch 101, mapper 102 sends the instruction into an issue queue 104. Instructions are issued from the issue queue to execution units 110, 112. Execution unit 110 is a fixed point execution unit and execution unit 112 is a load store execution unit. As instructions are issued to instruction units, operands are read from register file 106. Typically, operands are read in one cycle and the instructions execute. Then, the results are written back to register file 106 in the next cycle.

However, high frequency design of microprocessors requires more pipeline stages. As the number of pipeline stages increases, the need for larger register files increases. New technology, such as simultaneous multithreading, also requires larger register files. Eventually, a larger register file will force the register file access stage to be performed in more than one cycle to meet the frequency requirement. A multiple cycle operand access stage will degrade the performance of the processor.

Thus, it would be advantageous to provide a method and apparatus for accessing operands in a single cycle while still meeting the time demands of high frequency design.

### SUMMARY OF THE INVENTION

The present invention provides an operand buffer, each entry of which is allocated to an instruction in the issue queue. Thus, the operand buffer has the same number of entries as the issue queue. A register file is implemented for architected registers and temporary data. Data in the operand buffers are written from the register file at the time entries are allocated. When an instruction executes, then there is no need for the corresponding entry in the operand buffer and the entry is de-allocated. The operand buffer has fewer entries than the register file. Thus, an operand access stage requires a read of the operand buffer rather than the register file and the operand buffer can be read in one cycle.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a prior art microprocessor design;

FIGS. 2A, 2B, and 2C are pictorial representations of a microprocessor design in which the present invention may be implemented in accordance with a preferred embodiment of the present invention; and

FIG. 3 is a flowchart of the operation of the operand buffer in accordance with a preferred embodiment of the present invention.

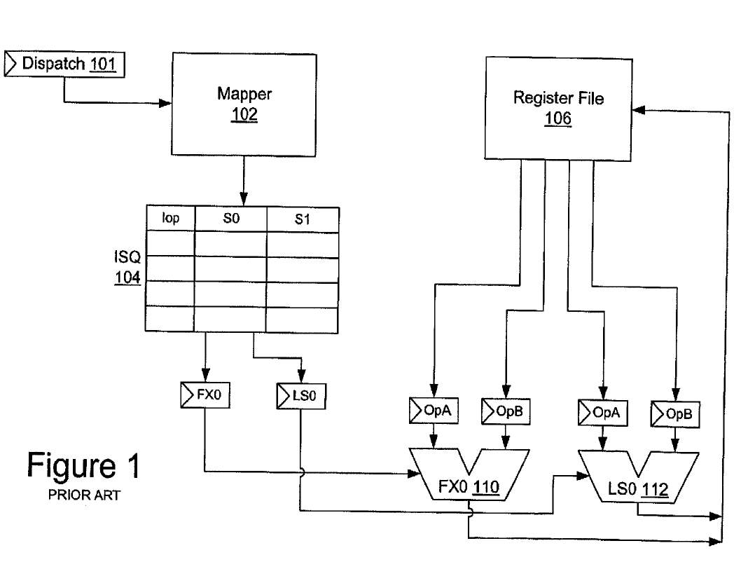

### DETAILED DESCRIPTION OF THE PREFERRED EMBODIMENT

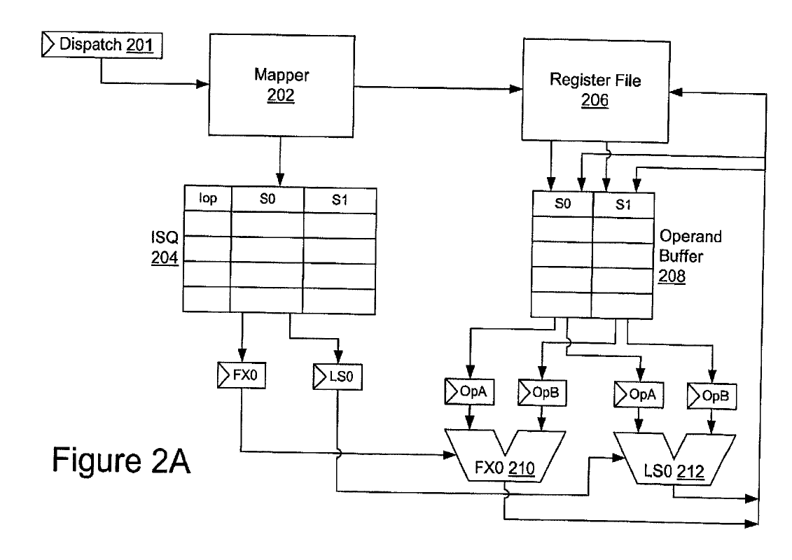

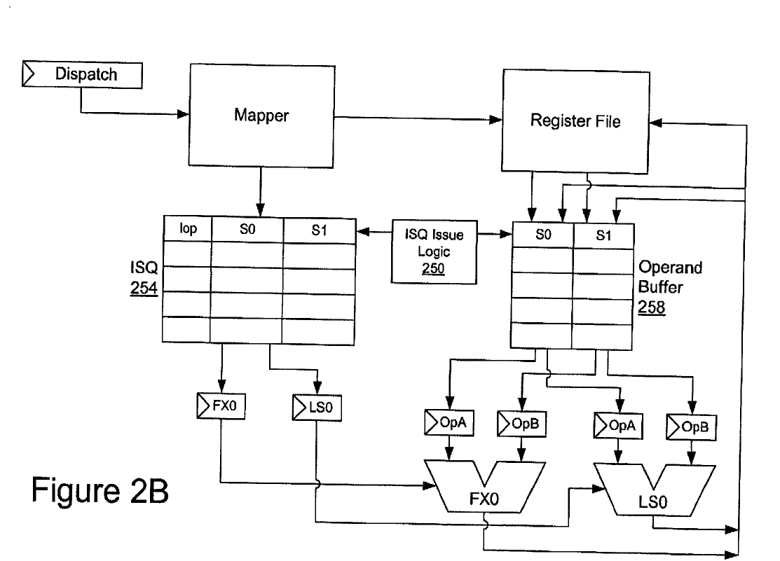

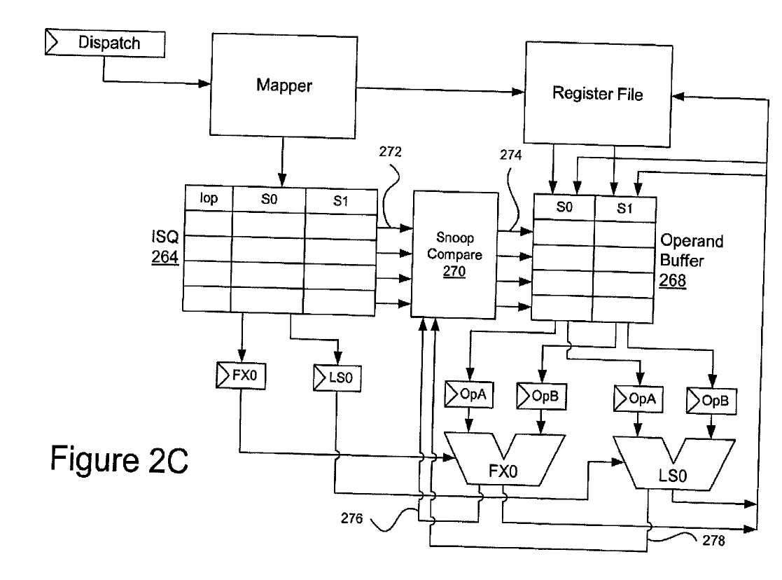

With reference now to the figures and in particular with reference to FIGS. 2A, 2B, and 2C, pictorial representations of a microprocessor design in which the present invention may be implemented are depicted in accordance with a preferred embodiment of the present invention. Particularly, with respect to FIG. 2A, instructions are received from dispatch 201 and mapper 202 sends instructions to issue queue (ISQ) 204. For each instruction sent to ISQ 204, mapper 202 instructs register file 206 to read operands into operand buffer 208. Operand buffer 208 has an entry for each entry in ISQ 204. However, the operand buffer has fewer entries than register file 206. Therefore, operands may be read from the register file at the time operand buffer entries are allocated. This read may take more than one cycle.

The processor selects the oldest instruction in ISQ 204 that has operands available and sends one instruction per execution unit. As instructions are issued to execution units 210, 212, the corresponding operands are read out from operand buffer 208 using the ISQ select pointer. This read from the operand buffer takes only one cycle. For simplicity, two execution units are shown. However, a superscalar processor design may include many such execution units, as is known in the art.

After execution by execution units 210, 212, data is written back to the register file using destination address tags and the operand buffers using snoop control provided by the ISQ. When ISQ selects an instruction from a location, the ISQ will also send the corresponding location pointer to the operand buffer to select the appropriate operand. This location pointer is referred to as the ISQ select pointer. ISQ compares returning destination address tags from the execution unit to its source operand address tags. If they match, then the data is stored in the data operand buffer at the appropriate location. This is referred to as snoop control.

With reference to FIG. 2B, ISQ issue logic 250 selects an instruction to be issued to an execution unit. ISQ issue logic 250 generates control signals to select instructions from ISA 254. The same control is used to select the operands (S0, S1) from operand buffer 258. This control signal is referred to as the ISQ select pointer.

With reference to FIG. 2C, snoop compare 270 compares destination address tags to all of the source operands in ISQ 264. When the execution units (FX0, LS0) send back destination address tags 276, 278, snoop compare 270 compares the incoming destination address tags to all of the source operands (S0, S1) in the ISQ. The compare results are used as buffer write back enable signals to write result data into operand buffer 268. For example, if the snoop compare indicates that result data corresponds to S0 of location N in the ISQ, then the buffer write back enable for S0 of location N in the operand buffer is active and the result data is written into the operand buffer.

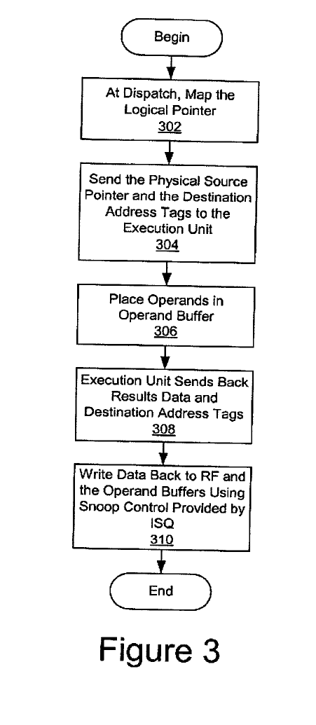

With reference now to FIG. 3, a flowchart of the operation of the operand buffer is shown in accordance with a preferred embodiment of the present invention. The process begins and, at dispatch, maps the logical pointer (step 302). Next, the process sends the physical source pointer and the destination address tags to the execution unit (step 304) and places operands in the operand buffer (step 306). Thereafter, the execution unit sends back results data and destination address tags (step 308). The process then writes data back to the register file and the operand buffers using snoop control provided by the ISQ (step 310) and the process ends.

Thus, the present invention solves the disadvantages of the prior art by providing an operand buffer. The operand buffer has the same number of entries as the issue queue. Operands are loaded into the operand buffer from the register file when entries are allocated to instructions in the issue queue. Therefore, since the register file is read ahead of time, the read can take multiple cycles. As instructions are issued to execution units in the processor, operands are read from the operand buffer. The read of the operand buffer takes one cycle.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for operand access in a processor, the method comprising:
assigning instructions to an issue queue;
reading operands for the instructions from a register file; and
loading the operands into an operand buffer to substantially maintain a match between the instructions in the issue queue with the operands in the operand buffer.

2. The method of claim 1, wherein the step of loading operands for the instructions into an operand buffer comprises:
allocating entries in the operand buffer to the instructions in the issue queue; and
loading the operands into the entries.

3. The method of claim 1, wherein the step of reading an operand from the register file takes more than one cycle.

4. The method of claim 1, further comprising:
selecting an issued instruction from the issue queue; and
sending the issued instruction to an execution unit.

5. The method of claim 4, further comprising:
reading operands corresponding to the issued instruction from the operand buffer; and
providing the operands corresponding to the issued instruction to the execution unit.

6. The method of claim 5, wherein the step of reading the operands corresponding to the issued instruction from the operand buffer takes one cycle.

7. The method of claim 5, wherein the step of reading the operands corresponding to the issued instruction from the operand buffer comprises using an issue queue select pointer.

8. The method of claim 4, further comprising:
writing a result from the execution unit to the register file.

9. The method of claim 4, further comprising:
writing a result from the execution unit to the operand buffer.

10. The method of claim 9, wherein the step of writing the result from the execution unit to the operand buffer comprises using snoop control provided by the issue queue.

11. An apparatus for operand access in a processor comprising:
an issue queue;
a mapper that assigns instructions to the issue queue;
a register file that stores operands; and
an operand buffer that stores operands for the instructions in the issue queue, wherein the operands in the operand buffer substantially match the instructions in the issue queue.

12. The apparatus of claim 11, wherein each entry in the operand buffer corresponds to an instruction in the issue queue.

13. The apparatus of claim 11, wherein the access stage for reading the operands from the register file takes more than one cycle.

14. The apparatus of claim 11, wherein the access stage for reading the operands from the operand buffer takes one cycle.

15. The apparatus of claim 11, wherein the issue queue and the operand buffer have the same number of entries.

16. An apparatus for operand access in a processor, the apparatus comprising:
assignment means for assigning instructions to an issue queue;
reading means for reading operands for the instructions from a register file; and
buffer means for loading the operands into an operand buffer.

17. The apparatus of claim 16, wherein the buffer means comprises:
allocation means for allocating entries in the operand buffer corresponding to the instructions in the issue queue; and
loading means for loading the operands into the entries.

18. The apparatus of claim 16, further comprising:
selection means for selecting an issued instruction from the issue queue; and
sending means for sending the issued instruction to an execution unit.

19. The apparatus of claim 18, further comprising:
means for reading operands corresponding to the issued instruction from the operand buffer; and
means for providing the operands corresponding to the issued instruction to the execution unit.

20. The apparatus of claim 19, wherein the means for reading the operands corresponding to the issued instruction from the operand buffer comprises an issue queue select pointer.

21. The apparatus of claim 19, further comprising:
means for writing a result from the execution unit to the register file.

22. The apparatus of claim 19, further comprising:
writing means for writing a result from the execution unit to the operand buffer.

23. The apparatus of claim 22, wherein the writing means comprises snoop control provided by the issue queue.
